(19) United States
(12) Patent Application Publication
(10) Pub. No.: US 2016/0330759 A1
(43) Pub. Date: Nov. 10, 2016

(54) MODIFIED CTS OR BLOCK ACKNOWLEDGEMENT FOR COEXISTENCE

(71) Applicant: QUALCOMM Incorporated, San Diego, CA (US)

(72) Inventors: Olaf Josef Hirsch, Sunnyvale, CA (US); James Simon Cho, Mountain View, CA (US); Simone Merlin, Solana Beach, CA (US); Youhan Kim, Fremont, CA (US); Guido Robert Frederiks, Aptos, CA (US); Jibing Wang, San Diego, CA (US)

(21) Appl. No.: 14/706,307

(22) Filed: May 7, 2015

(51) Int. Cl. H04W 72/12; H04L 29/06; H04L 12/743; H04W 74/08

(52) U.S. Cl. CPC H04W 72/1278; H04W 74/0816; H04L 69/22; H04W 72/1236; H04L 45/7453

(57) ABSTRACT

Methods, systems, and devices are described for wireless communication. A wireless device may identify an upcoming interference period, determine a receive end time based on when the interference period will begin to disrupt incoming messages, and transmit a scheduling outlook message to a transmitter to schedule around the interference in response to receiving a packet (request-to-send (RTS) or data). The wireless device may hash a receiver address (RA) associated with the packet exchange message such as a clear-to-send message or a block acknowledgement to make room for the scheduling outlook message. An example scheduling outlook field (in the place of the full RA field) may include a shortened RA, a number of supported spatial streams, a supported bandwidth, a set of tone allocation units (TAUs), a receive end time (or receive duration), and an interference level.

### BACKGROUND

1. Field of Disclosure

The following relates generally to wireless communication, and more specifically to modified clear-to-send (CTS) or block acknowledgement for coexistence.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), such as a wireless fidelity (Wi-Fi) (i.e., IEEE 802.11) network may include an access point (AP) that may communicate with one or more station (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the STA to the AP.

In some cases, a wireless device such as a WLAN station may be subject to local interference, such as that created by a collocated Bluetooth or other human interface device. This interference may prevent the wireless device from effectively receiving incoming messages during periods when the interference is above a certain threshold.

### SUMMARY

In one example, a wireless device may identify an upcoming interference period, determine a receive end time based on when the interference period will begin to disrupt incoming messages, and transmit a scheduling outlook message to a transmitter to schedule around the interference in response to receiving a packet (request-to-send (RTS) or data). The wireless device may hash a receiver address (RA) associated with a packet exchange message, such as a CTS message or a block acknowledgement to make room for the scheduling outlook message. In some cases, the wireless device may be provided with a short RA with fewer bits than the RA field of the packet exchange message. An example scheduling outlook message field (in the place of the full RA field) may include a shortened RA, a number of supported spatial streams, a supported bandwidth, a set of tone allocation units (TAUs), a receive end time (or receive duration), and/or an interference level.

A method of wireless communication is described. The method may include identifying an upcoming interference period, determining a receive end time based at least in part on the upcoming interference period, and transmitting a scheduling outlook message comprising the receive end time.

An apparatus for wireless communication is described. The apparatus may include an interference identifier for identifying an upcoming interference period, an end time manager for determining a receive end time based at least in part on the upcoming interference period, and a scheduling outlook controller for transmitting a scheduling outlook message comprising the receive end time.

A further apparatus for wireless communication is described. The apparatus may include a processor, memory in electronic communication with the processor, and instructions stored in the memory and operable, when executed by the processor, to cause the apparatus to identify an upcoming interference period, determine a receive end time based at least in part on the upcoming interference period, and transmit a scheduling outlook message comprising the receive end time.

A non-transitory computer-readable medium storing code for wireless communication is described. The code may include instructions executable to identify an upcoming interference period, determine a receive end time based at least in part on the upcoming interference period, and transmit a scheduling outlook message comprising the receive end time.

Some examples of the method, apparatuses, or non-transitory computer-readable medium described herein may further include processes, features, means, or instructions for incorporating the scheduling outlook message into a packet exchange message, wherein transmitting the scheduling outlook message comprises transmitting the packet exchange message. Additionally or alternatively, some examples may include processes, features, means, or instructions for hashing a receiver address associated with a packet exchange message, wherein incorporating the scheduling outlook message is based at least in part on the hashed receiver address.

Some examples of the method, apparatuses, or non-transitory computer-readable medium described herein may further include processes, features, means, or instructions for receiving a short receiver address comprising fewer bits than a receiver address field of the packet exchange message, wherein incorporating the scheduling outlook message is based at least in part on the short receiver address. Additionally or alternatively, in some examples the scheduling outlook message is incorporated in a receiver address field of the packet exchange message.

In some examples of the method, apparatuses, or non-transitory computer-readable medium described herein, the packet exchange message is an automatic response message. Additionally or alternatively, in some examples the automatic response message is a CTS frame.

In some examples of the method, apparatuses, or non-transitory computer-readable medium described herein, the packet exchange message is a block acknowledgement message. Additionally or alternatively, some examples may include processes, features, means, or instructions for receiving a data transmission based at least in part on the scheduling outlook message.

In some examples of the method, apparatuses, or non-transitory computer-readable medium described herein, the data transmission comprises a duration, a modulation and coding scheme (MCS), a start time, an end time, or any combination thereof based at least in part on the scheduling outlook message. Additionally or alternatively, in some examples the scheduling outlook message comprises a number of supported spatial streams, a supported bandwidth, a tone allocation unit (TAU) bitmap, an interference level, or any combination thereof.

Some examples of the method, apparatuses, or non-transitory computer-readable medium described herein may further include processes, features, means, or instructions for identifying an interference pattern based at least in part on a local interference source, wherein identifying the upcoming interference period is based at least in part on the interference pattern. Additionally or alternatively, in some examples the interference pattern is based at least in part on a periodic interference pattern, a quasi-periodic interference pattern, an aperiodic interference pattern, or any combination thereof.

In some examples of the method, apparatuses, or non-transitory computer-readable medium described herein, the local interference source is a collocated device. Additionally or alternatively, in some examples the local interference source is a Bluetooth device, a human interface device, a wide area network (WAN) device, or any combination thereof.

In some examples of the method, apparatuses, or non-transitory computer-readable medium described herein, the receive end time is based at least in part on the beginning of the upcoming interference period.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) (also known as a wireless fidelity (Wi-Fi) network) for modified clear-to-send (CTS) or block acknowledgement for coexistence configured in accordance with various aspects of the present disclosure;

FIG. 2 illustrates an example of a wireless communications subsystem that supports modified CTS or block acknowledgement for coexistence in accordance with various aspects of the present disclosure;

FIG. 3 illustrates an example of a process flow that supports modified CTS or block acknowledgement for coexistence in accordance with various aspects of the present disclosure;

FIGS. 4-6 show block diagrams of a wireless device that supports modified CTS or block acknowledgement for coexistence in accordance with various aspects of the present disclosure;

FIG. 7 illustrates a block diagram of a system including a station (STA) that supports modified CTS or block acknowledgement for coexistence in accordance with various aspects of the present disclosure; and

FIGS. 8-13 illustrate methods for modified CTS or block acknowledgement for coexistence in accordance with various aspects of the present disclosure.

### DETAILED DESCRIPTION

A wireless device may identify an upcoming interference period, determine a receive end time based on when the interference period will begin to disrupt incoming messages, and transmit a scheduling outlook message to a transmitter to schedule around the interference in response to receiving a packet (request-to-send (RTS) or data). The wireless device may hash a receiver address (RA) associated with a packet exchange message such as a CTS message or a block acknowledgement to make room for the scheduling outlook message. In some cases, the wireless device may be provided with a short RA with fewer bits than the RA field of the packet exchange message. An example scheduling outlook message field (in the place of the full RA field) may include a shortened RA, a number of supported spatial streams, a supported bandwidth, a set of tone allocation units (TAUs), a receive end time (or receive duration), and an interference level.

Aspects of the disclosure are described in the context of a wireless local area network (WLAN), but the methods and apparatuses may also be used in the context of other wireless communication scenarios. The disclosure is further illustrated by and described with reference to apparatus diagrams, system diagrams, and flowcharts that relate to modified CTS or block acknowledgement for coexistence.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

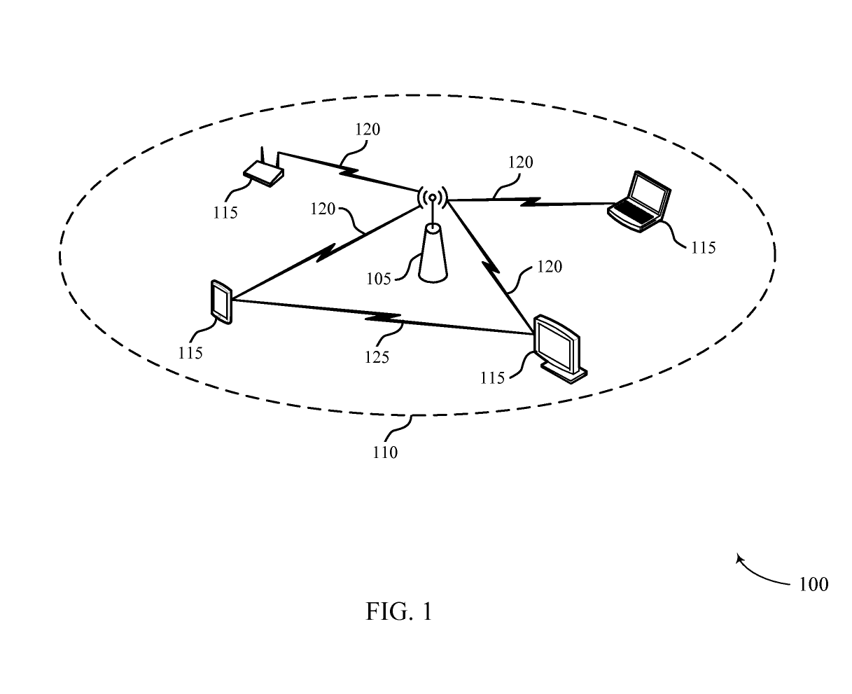

FIG. 1 illustrates a WLAN 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network may be able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system (DS) that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (DS) (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate via link 120 according to the WLAN radio and baseband protocol for physical (PHY) and medium access control (MAC) layers from IEEE 802.11 and versions including, but not limited to, 802.11b, 802.11g, 802.11a, 802.11n, 802.11 ac, 802.11 ad, 802.11 ah, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment because the STAs 115 may not refrain from transmitting on top of each other (e.g., in a carrier sense multiple access with collision avoidance (CSMA/CA) based system). A STA 115 whose transmissions are not identifiable, but that is within the same coverage area 110 may be known as a hidden node. CSMA/CA may be supplemented by the exchange of a request-to-send (RTS) packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem. Once the data packet is transmitted, the receiver may respond with an acknowledgement for a packet data unit (PDU) or a block of PDUs (in a block acknowledgement (BA)) to indicate that the packet was successfully received.

Thus, a wireless device such as a STA 115 may identify an upcoming interference period, determine a receive end time based on when the interference period will begin to disrupt incoming messages, and transmit a scheduling outlook message to an AP 105 to schedule around the interference in response to receiving a packet (request-to-send (RTS) or data). The STA 115 may hash an RA associated with the packet exchange message, such as a CTS or a BA, to make room for the scheduling outlook message. In some cases, the STA 115 may be provided with a short RA with fewer bits than the RA field of the packet exchange message. An example scheduling outlook message field (in the place of the full RA field) may include a shortened RA, a number of supported spatial streams, a supported bandwidth, a set of TAUs, a receive end time (or receive duration), and an interference level.

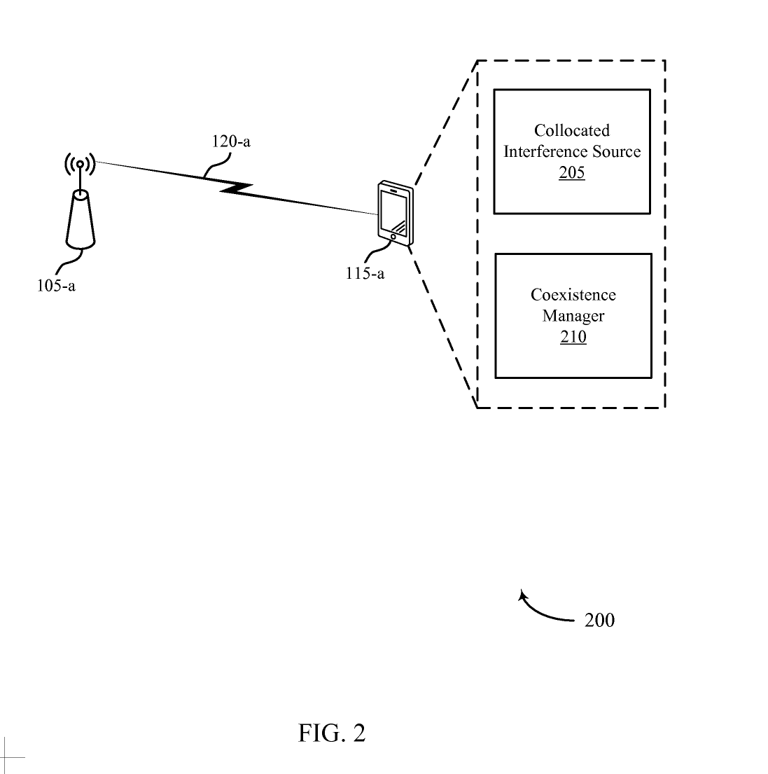

FIG. 2 illustrates an example of a wireless communications subsystem 200 for modified CTS or BA for coexistence in accordance with various aspects of the present disclosure. Wireless communications subsystem 200 may include a STA 115-a and an AP 105-a which may be examples of a STA 115 or an AP 105 described herein with reference to FIG. 1. STA 115-a may identify an upcoming interference period, determine a receive end time based on when the interference period will begin to disrupt incoming messages, and transmit a scheduling outlook message to AP 105-a to schedule around the interference in response to receiving a packet (request-to-send (RTS) or data).

STA 115-a may include a collocated interference source 205 (or, in some examples, a nearby but non-collocated interference source) such as a Bluetooth device, a human interface device, or a wide area network (WAN) transmitter. Thus, STA 115-a may also include a coexistence manager 210 to mitigate the effects of interference from the local interference source.

Local interference may be a superposition of periodic events, or periodic events superimposed with non-period events (e.g., a Bluetooth (BT) Synchronous Connection Oriented (SCO) link with additional packets for BT link control and volume setting). It can also be quasi-periodic (e.g. advanced audio distribution profile (A2DP) messages), or irregular (e.g. arbitrary BT traffic, page/inquiries). In some cases, local interference can prevent a STA 115-a from transmitting or receiving entirely. For example, a STA 115-a may share an antenna or a WLAN receive/transmit chain might be temporarily switched to a different frequency.

AP 105-a (which may be an example of a generic remote transmitter) may not have sufficient information about the interference conditions to compensate for the interference. Thus, STA 115-a may attempt to ensure that it is not scheduled to receive data (or, in some cases, transmit data) during periods characterized by collocated interference.

In some systems WLAN coexistence implementations may utilize WLAN MAC features (e.g., power save polling (PS-POLL), clear-to-send-to-self (CTS2S), or NULL frame flow control) that were not created for the purpose of preempting transmissions during periods characterized by collocated interference. These features may not have the capacity to address the problem efficiently. Other systems may address the issue by providing means for a device collocated with an interference source to provide information to the remote device (e.g., Unscheduled Automatic Power Save Delivery (U-APSD)). In some cases, these solutions may not be sufficiently flexible to handle all interference scenarios (e.g., they may be limited to periodic interference).

Thus STA115-a may include scheduling information (e.g., information about the availability of the device to receive transmissions) into the packet exchange based at least in part on local interference. This may provide a scheduling outlook message for the current or next frame exchange sequence (FES). A device may use existing CTS or BA transmissions to provide a scheduling outlook message such as a time until the device may be able to receive additional packets. That is, the device may modify CTS or BA receiver address (RA) such that it can carry additional coexistence information. A full RA may have 48 bits, but in the case of CTS and BA there may also be a strong relationship to short interframe space (SIFS). Thus, the RA may be effectively shortened with a hash function to make room for additional information. That is, the receiver identity may be specified with fewer than, e.g., 48 bits. In some cases, nine bits may be used for the RA. With a shortened RA, the BA or another FES message may be used to convey the receiver availability for the next frame after SIFS. This may allow the extension to work for SIFS bursting as well. Including a scheduling information extension may enable a device to compensate for both periodic and aperiodic interference.

In some cases, STA 115-a may send the scheduling outlook message in response to an incoming request to send or (RTS) unicast packet. For example, a remote WLAN device such as AP 105-a may send an RTS or unicast packet to STA 115-a (that has the collocated interference). STA 115-a may then check with collocated interference source 205 about the upcoming traffic or otherwise estimate the interference from collocated interference source 205. Based on the upcoming traffic or interference estimation, STA 115-a may send back a scheduling outlook message (such as in a modified CTS packet). AP 105-a may then look at the scheduling outlook message and use that information to transmit data to STA 115-a so that it avoids the collocated interference.

An example information field (e.g., in the place of a 48 bit RA) may include a short RA, a number of supported spatial streams, a supported bandwidth, a set of TAUs, a receive end time (or receive duration), and an interference level. The short RA may either be hashed by STA 115-a or provided by AP 105-a. The number of supported spatial streams may vary dynamically and may be indicated using, e.g., four bits. The supported bandwidth may vary from packet to packet as well (e.g., between 20 MHz, 40 MHz, 80+80 MHz, and 160 MHz) due to interference or available resources and may use, e.g., three bits. The TAU allocation may include spurs, harmonics, intermods, or desense TAUS and may utilize eight bits. The receive end time may take into account time to receive a packet and time to send a BA, and may utilize 12 bits. The interference level may be the signal-to-noise ratio (SNR) of a previous RTS, and may be used by AP 105-a to determine a modulation and coding scheme (MCS) rate. The interference level may utilize eight bits. A number of bits may also be reserved.

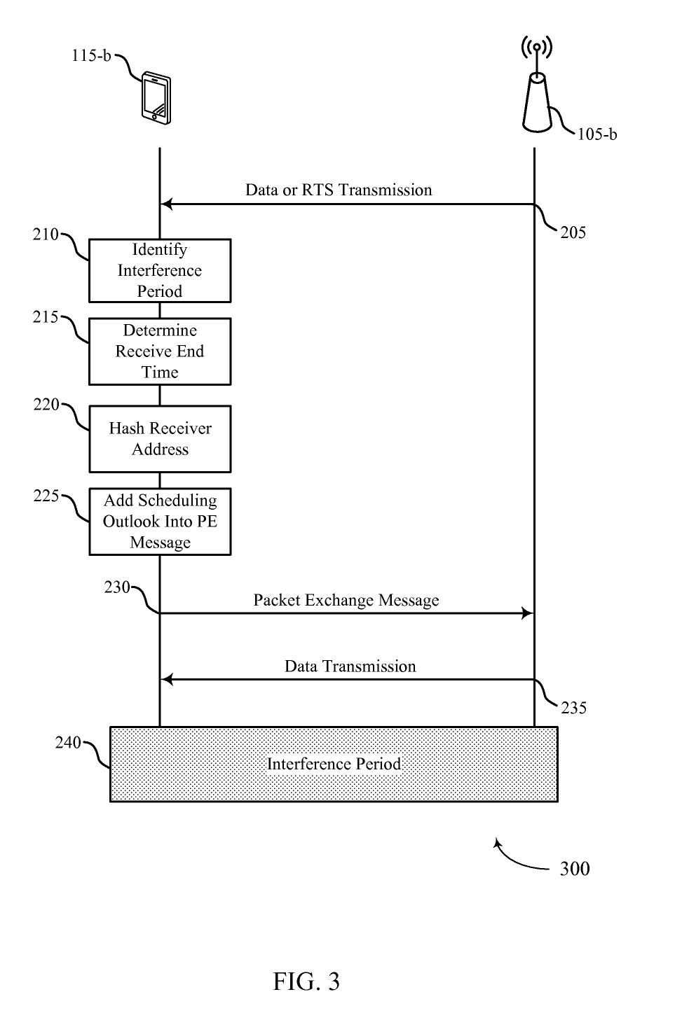

FIG. 3 illustrates an example of a process flow 300 for modified CTS or block acknowledgement for coexistence in accordance with various aspects of the present disclosure. Process flow 300 may include STA 115-b and AP 105-b, which may be examples of a STA 115 or an AP 105 described herein with reference to FIGS. 1-2.

At 205, STA 115-b may receive an RTS or unicast packet from AP 105-b.

At 210, STA 115-b may identify an upcoming interference period (e.g., an interference period based on an interference pattern of a local interference source). In some examples the interference pattern is based at least in part on a periodic interference pattern, a quasi-periodic interference pattern, an aperiodic interference pattern, or any combination thereof. In some examples the local interference source is a collocated device. In some examples the local interference source is a Bluetooth device, a human interface device, a wide area network (WAN) device, or any combination thereof. In some examples the receive end time is based at least in part on the beginning of the upcoming interference period.

At 215, STA 115-b may determine a receive end time based at least in part on the upcoming interference period. At 220, STA 115-b may hash an RA associated with the packet exchange message such as a CTS or a BA message. Alternatively, the shortened RA may be received from AP 105-b.

At 225, STA 115-b may incorporate a scheduling outlook message including the receive end time into a packet exchange message. For example, the hashed RA may be fewer bits than the RA field of the packet exchange message, such that the scheduling outlook message may be included in what was previously used as the RA field. In some examples the scheduling outlook message includes a number of supported spatial streams, a supported bandwidth, a TAU bitmap, an interference level, or any combination.

At 230, STA 115-b may transmit the packet exchange message (and thus, the scheduling outlook message) to AP 105-b.

At 235, STA 115-b may receive a data transmission from AP 105-b based at least in part on the scheduling outlook message. In some examples, the data transmission comprises a duration, a MCS, a start time, an end time, or any combination based on the scheduling outlook message.

At 240, the interference period may prevent effective communications between STA 115-a and AP 105-b.

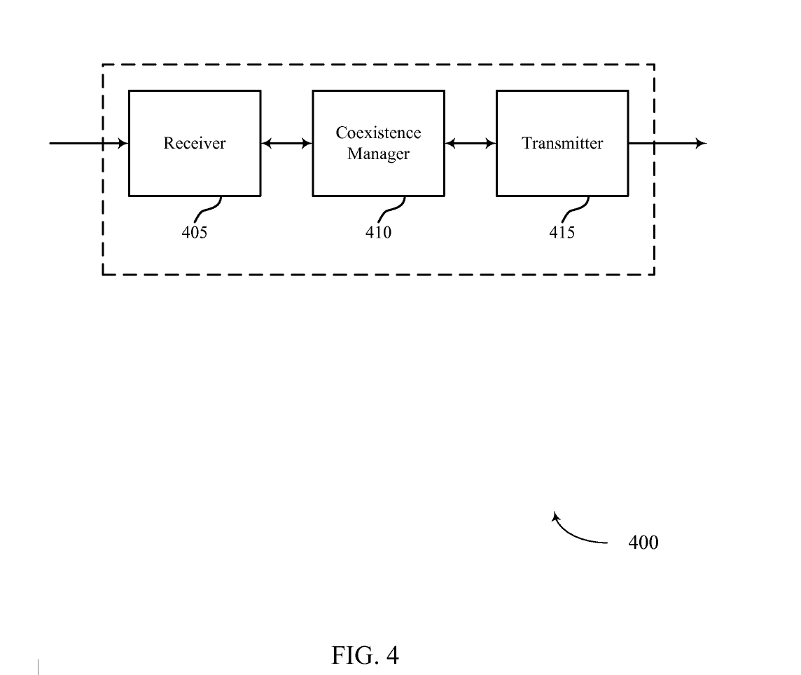

FIG. 4 shows a block diagram of a wireless device 400 configured for modified CTS or block acknowledgement for coexistence in accordance with various aspects of the present disclosure. Wireless device 400 may be an example of aspects of a STA 115 with a collocated interference source as described with reference to FIGS. 1-3. Wireless device 400 may include a receiver 405, a coexistence manager 410, or a transmitter 415. Wireless device 400 may also include a processor. Each of these components may be in communication with each other.

The receiver 405 may receive information such as packets, user data, or control information associated with various information channels (e.g., wireless information from an AP 105 such as control channels, data channels, and information related to modified CTS or block acknowledgement for coexistence, etc.). Information may be passed on to the coexistence manager 410, and to other components of wireless device 400. In some examples, the receiver 405 may receive a data transmission based at least in part on the scheduling outlook message. In some examples, the data transmission comprises a duration, an MCS, a start time, an end time, or any combination thereof based at least in part on the scheduling outlook message.

The coexistence manager 410 may identify an upcoming interference period, determine a receive end time based at least in part on the upcoming interference period, and transmit a scheduling outlook message comprising the receive end time.

The transmitter 415 may transmit signals received from other components of wireless device 400. In some examples, the transmitter 415 may be collocated with the receiver 405 in a transceiver module. The transmitter 415 may include a single antenna, or it may include a plurality of antennas.

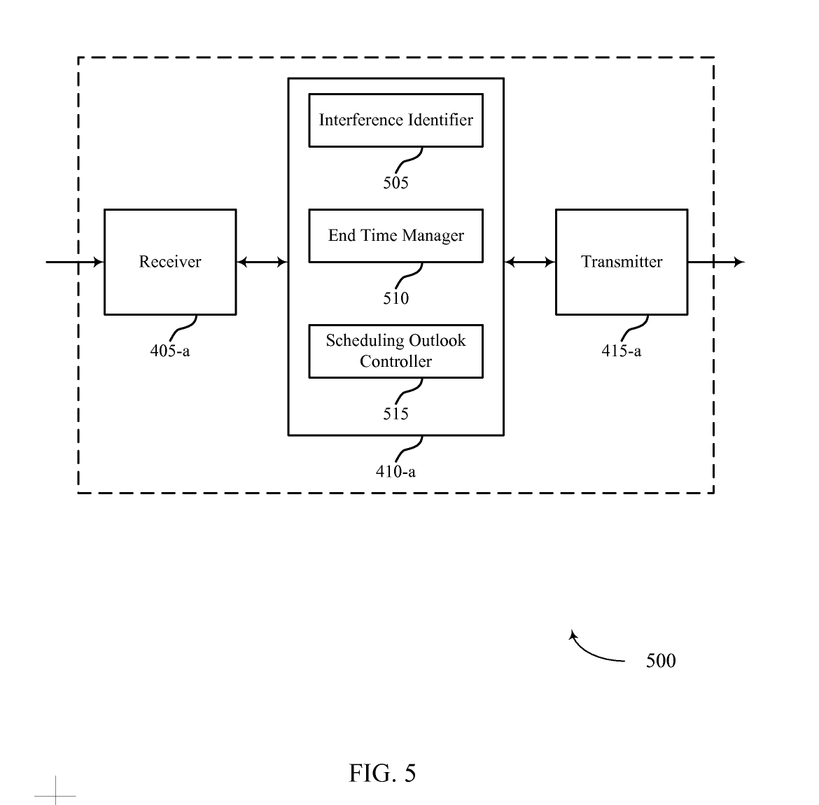

FIG. 5 shows a block diagram of a wireless device 500 for modified CTS or block acknowledgement for coexistence in accordance with various aspects of the present disclosure. Wireless device 500 may be a device with a collocated interference source such as a wireless device 400 or a STA 115 described with reference to FIGS. 1-4. Wireless device 500 may include a receiver 405-a, a coexistence manager 410-a, and a transmitter 415-a. Wireless device 500 may also include a processor. Each of these components may be in communication with each other. The coexistence manager 410-a may also include an interference identifier 505, an end time manager 510, and a scheduling outlook controller 515.

The receiver 405-a may receive information which may be passed on to coexistence manager 410-a, and to other components of wireless device 500. The coexistence manager 410-a may perform the operations described herein with reference to FIG. 4. The transmitter 415-a may transmit signals received from other components of wireless device 500.

The interference identifier 505 may identify an upcoming interference period as described herein with reference to FIGS. 2-3. The interference identifier 505 may also identify an interference pattern based at least in part on a local interference source, wherein identifying the upcoming interference period is based at least in part on the interference pattern. In some examples, the interference pattern may be based at least in part on a periodic interference pattern, a quasi-periodic interference pattern, an aperiodic interference pattern, or any combination thereof. In some cases, the interference information may be provided by the source of the interference (i.e., it may provide upcoming traffic information).

The end time manager 510 may determine a receive end time based at least in part on the upcoming interference period as described herein with reference to FIGS. 2-3. In some examples, the receive end time may be based at least in part on the beginning of the upcoming interference period.

The scheduling outlook controller 515 may transmit a scheduling outlook message to comprising the receive end time as described herein with reference to FIGS. 2-3. The scheduling outlook controller 515 may also incorporate the scheduling outlook message into a packet exchange message, wherein transmitting the scheduling outlook message comprises transmitting the packet exchange message. In some examples, the scheduling outlook message may be incorporated in an RA field of the packet exchange message. In some examples, the packet exchange message may be an automatic response message. In some examples, the automatic response message may be a CTS frame. In some examples, the packet exchange message may be a block acknowledgement message. In some examples, the scheduling outlook message comprises a number of supported spatial streams, a supported bandwidth, a tone allocation unit (TAU) bitmap, an interference level, or any combination thereof.

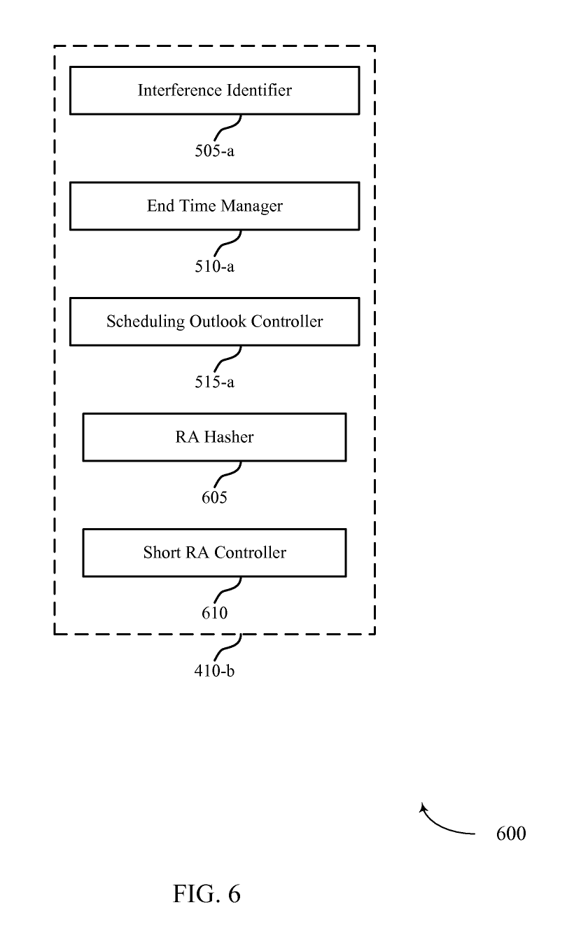

FIG. 6 shows a block diagram 600 of a coexistence manager 410-b which may be a component of a wireless device 400 or a wireless device 500 for modified CTS or block acknowledgement for coexistence in accordance with various aspects of the present disclosure. The coexistence manager 410-b may be an example of aspects of a coexistence manager 410 described with reference to FIGS. 4-5. The coexistence manager 410-b may include an interference identifier 505-a, an end time manager 510-a, and a scheduling outlook controller 515-a. Each of these modules may perform the functions described herein with reference to FIG. 5. The coexistence manager 410-b may also include an RA hasher 605, and a short RA controller 610.

The RA hasher 605 may hash an RA associated with the packet exchange message, wherein incorporating the scheduling outlook message is based at least in part on the shortened RA as described herein with reference to FIGS. 2-3.

The short RA controller 610 may receive a short RA comprising fewer bits than an RA field of the packet exchange message, wherein incorporating the scheduling outlook message is based at least in part on the short RA as described herein with reference to FIGS. 2-3.

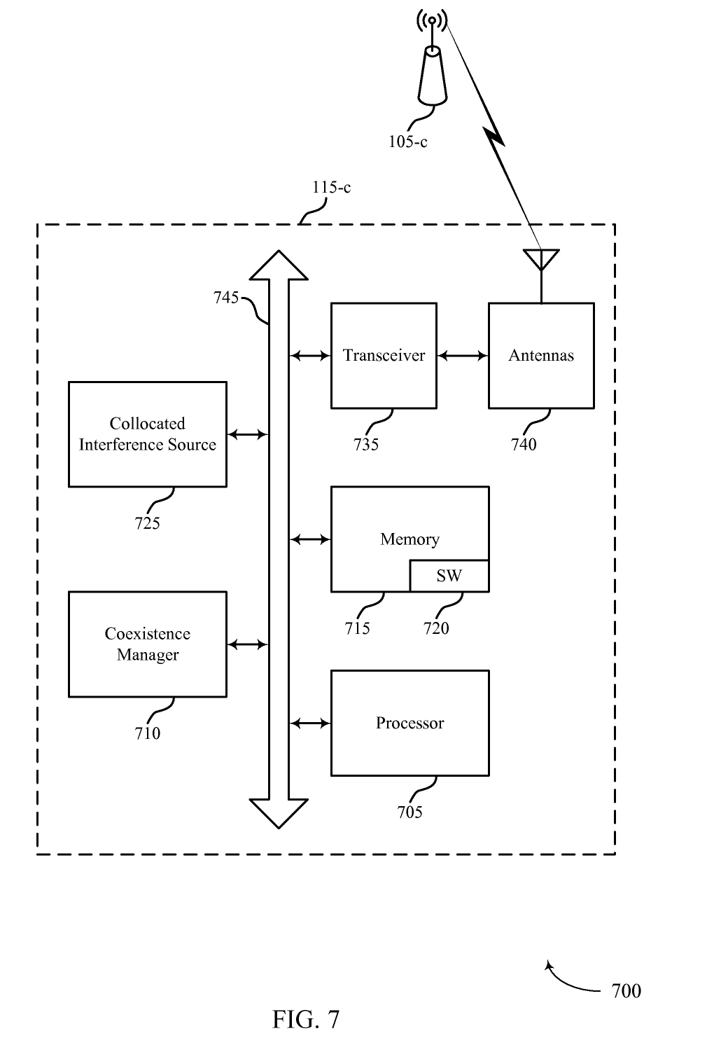

FIG. 7 shows a diagram of a system 700 including a STA 115 configured for modified CTS or block acknowledgement for coexistence in accordance with various aspects of the present disclosure. System 700 may include STA 115-c, which may be an example of a wireless device 400, a wireless device 500, or a STA 115 described herein with reference to FIGS. 1, 2 and 4-6. STA 115-c may include a coexistence manager 710, which may be an example of a coexistence manager 410 described with reference to FIGS. 4-6. STA 115-c may also include a collocated interference source 725. STA 115-c may also include components for bi-directional voice and data communications including components for transmitting communications and components for receiving communications. For example, STA 115-c may communicate bi-directionally with AP 105-c.

The collocated interference source 725 be an example of a collocated device causing local interference as described herein with reference to FIGS. 2-3. In some examples, the local interference source may be a Bluetooth device, a human interface device, a wide area network (WAN) device, or any combination thereof. In some examples, the local interference source is not collocated within STA 115-c.

STA 115-c may also include a processor 705, and memory 715 (including software (SW)) 720, a transceiver 735, and one or more antenna(s) 740, each of which may communicate, directly or indirectly, with one another (e.g., via buses 745). The transceiver 735 may communicate bi-directionally, via the antenna(s) 740 or wired or wireless links, with one or more networks, as described above. For example, the transceiver 735 may communicate bi-directionally with an AP 105 or another STA 115. The transceiver 735 may include a modem to modulate the packets and provide the modulated packets to the antenna(s) 740 for transmission, and to demodulate packets received from the antenna(s) 740. While STA 115-c may include a single antenna 740, STA 115-c may also have multiple antennas 740 capable of concurrently transmitting or receiving multiple wireless transmissions.

The memory 715 may include random access memory (RAM) and read only memory (ROM). The memory 715 may store computer-readable, computer-executable software/firmware code 720 including instructions that, when executed, cause the processor 705 to perform various functions described herein (e.g., modified CTS or block acknowledgement for coexistence, etc.). Alternatively, the software/firmware code 720 may not be directly executable by the processor 705 but cause a computer (e.g., when compiled and executed) to perform functions described herein. The processor 705 may include an intelligent hardware device, (e.g., a central processing unit (CPU), a microcontroller, an ASIC, etc.)

The components of wireless device 400, wireless device 500, coexistence manager 410 or system 700 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

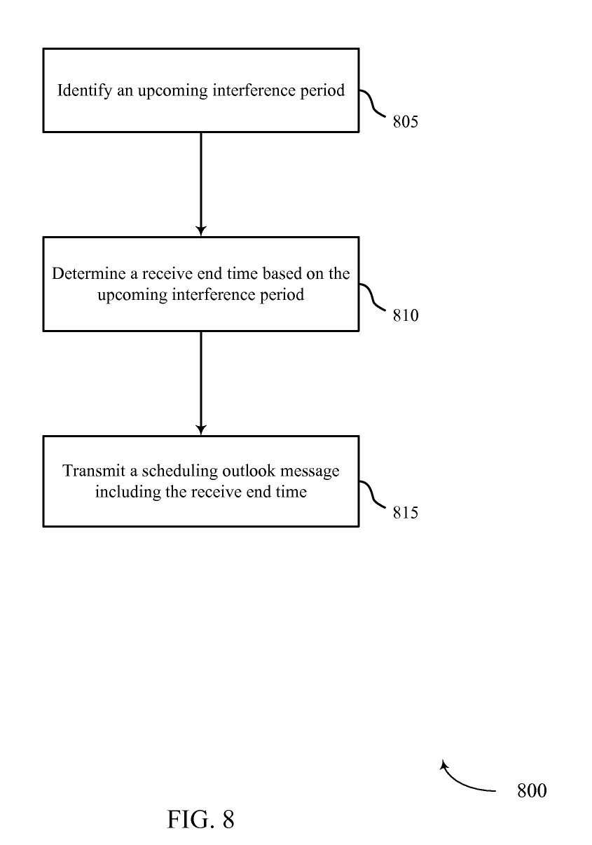

FIG. 8 shows a flowchart illustrating a method 800 for modified CTS or block acknowledgement for coexistence in accordance with various aspects of the present disclosure. The operations of method 800 may be implemented by a STA 115 or its components as described with reference to FIGS. 1-7. For example, the operations of method 800 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware.

At block 805, the STA 115 may identify an upcoming interference period as described herein with reference to FIGS. 2-3. In certain examples, the operations of block 805 may be performed by the interference identifier 505 as described herein with reference to FIG. 5.

At block 810, the STA 115 may determine a receive end time based at least in part on the upcoming interference period as described herein with reference to FIGS. 2-3. In certain examples, the operations of block 810 may be performed by the end time manager 510 as described herein with reference to FIG. 5.

At block 815, the STA 115 may transmit a scheduling outlook message comprising the receive end time as described herein with reference to FIGS. 2-3. In certain examples, the operations of block 815 may be performed by the scheduling outlook controller 515 as described herein with reference to FIG. 5.

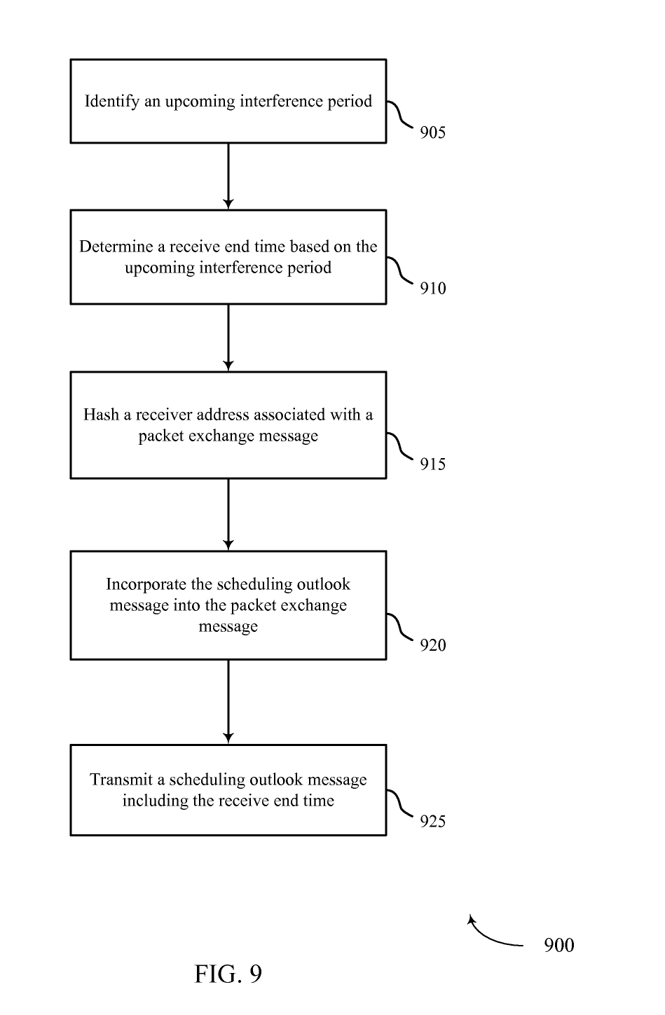

FIG. 9 shows a flowchart illustrating a method 900 for modified CTS or block acknowledgement for coexistence in accordance with various aspects of the present disclosure. The operations of method 900 may be implemented by a STA 115 or its components as described with reference to FIGS. 1-7. For example, the operations of method 900 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware. The method 900 may also incorporate aspects of method 800 of FIG. 8.

At block 905, the STA 115 may identify an upcoming interference period as described herein with reference to FIGS. 2-3. In certain examples, the operations of block 905 may be performed by the interference identifier 505 as described herein with reference to FIG. 5.

At block 910, the STA 115 may determine a receive end time based at least in part on the upcoming interference period as described herein with reference to FIGS. 2-3. In certain examples, the operations of block 910 may be performed by the end time manager 510 as described herein with reference to FIG. 5.

At block 915, the STA 115 may hash an RA associated with the packet exchange message, wherein incorporating the scheduling outlook message is based at least in part on the shortened RA as described herein with reference to FIGS. 2-3. In certain examples, the operations of block 915 may be performed by the RA hasher 605 as described herein with reference to FIG. 6.

At block 920, the STA 115 may incorporate the scheduling outlook message into a packet exchange message, wherein transmitting the scheduling outlook message comprises transmitting the packet exchange message as described herein with reference to FIGS. 2-3. In certain examples, the operations of block 920 may be performed by the scheduling outlook controller 515 as described herein with reference to FIG. 5.

At block 925, the STA 115 may transmit a scheduling outlook message comprising the receive end time as described herein with reference to FIGS. 2-3. In certain examples, the operations of block 925 may be performed by the scheduling outlook controller 515 as described herein with reference to FIG. 5.

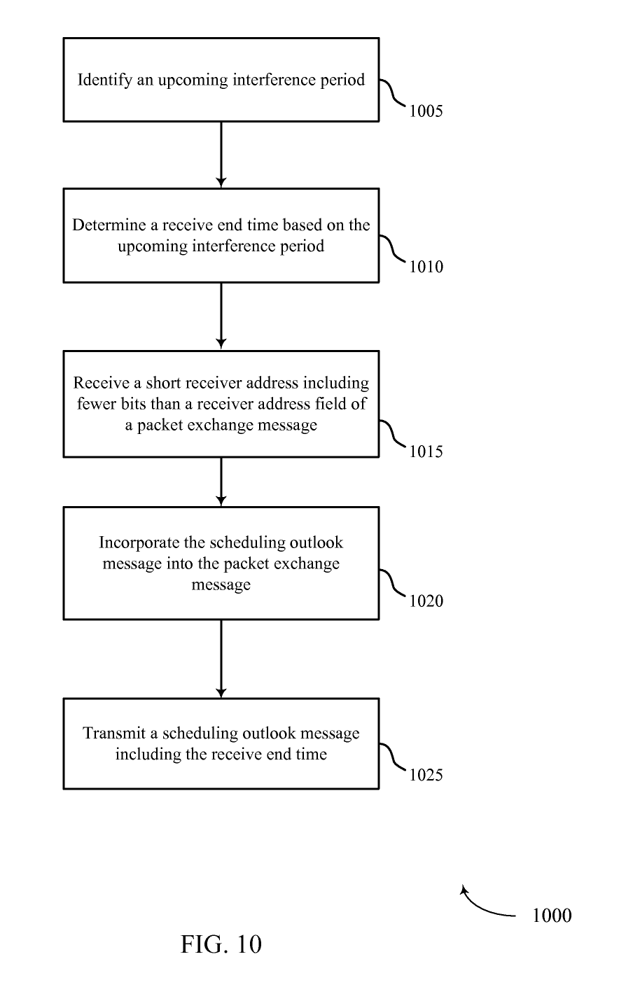

FIG. 10 shows a flowchart illustrating a method 1000 for modified CTS or block acknowledgement for coexistence in accordance with various aspects of the present disclosure. The operations of method 1000 may be implemented by a STA 115 or its components as described with reference to FIGS. 1-7. For example, the operations of method 1000 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware. The method 1000 may also incorporate aspects of methods 800, and 900 of FIGS. 8-9.

At block 1005, the STA 115 may identify an upcoming interference period as described herein with reference to FIGS. 2-3. In certain examples, the operations of block 1005 may be performed by the interference identifier 505 as described herein with reference to FIG. 5.

At block 1010, the STA 115 may determine a receive end time based at least in part on the upcoming interference period as described herein with reference to FIGS. 2-3. In certain examples, the operations of block 1010 may be performed by the end time manager 510 as described herein with reference to FIG. 5.

At block 1015, the STA 115 may receive a short RA comprising fewer bits than an RA field of the packet exchange message, wherein incorporating the scheduling outlook message is based at least in part on the short RA as described herein with reference to FIGS. 2-3. In certain examples, the operations of block 1015 may be performed by the short RA controller 610 as described herein with reference to FIG. 6.

At block 1020, the STA 115 may incorporate the scheduling outlook message into a packet exchange message, wherein transmitting the scheduling outlook message comprises transmitting the packet exchange message as described herein with reference to FIGS. 2-3. In certain examples, the operations of block 1020 may be performed by the scheduling outlook controller 515 as described herein with reference to FIG. 5.

At block 1025, the STA 115 may transmit a scheduling outlook message comprising the receive end time as described herein with reference to FIGS. 2-3. In certain examples, the operations of block 1025 may be performed by the scheduling outlook controller 515 as described herein with reference to FIG. 5.

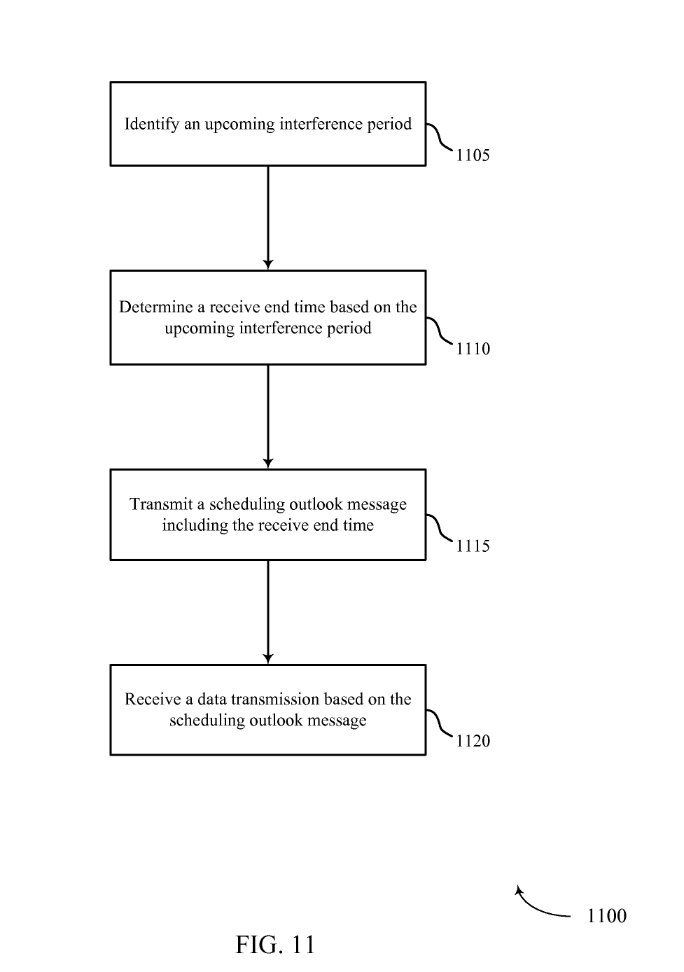

FIG. 11 shows a flowchart illustrating a method 1100 for modified CTS or block acknowledgement for coexistence in accordance with various aspects of the present disclosure. The operations of method 1100 may be implemented by a STA 115 or its components as described with reference to FIGS. 1-7. For example, the operations of method 1100 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware. The method 1100 may also incorporate aspects of methods 800, 900, and 1000 of FIGS. 8-10.

At block 1105, the STA 115 may identify an upcoming interference period (e.g., by receiving traffic information from a collocated interference source) as described herein with reference to FIGS. 2-3. In certain examples, the operations of block 1105 may be performed by the interference identifier 505 as described herein with reference to FIG. 5.

At block 1110, the STA 115 may determine a receive end time based at least in part on the upcoming interference period as described herein with reference to FIGS. 2-3. In certain examples, the operations of block 1110 may be performed by the end time manager 510 as described herein with reference to FIG. 5.

At block 1115, the STA 115 may transmit a scheduling outlook message comprising the receive end time as described herein with reference to FIGS. 2-3. In certain examples, the operations of block 1115 may be performed by the scheduling outlook controller 515 as described herein with reference to FIG. 5.

At block 1120, the STA 115 may receive a data transmission based at least in part on the scheduling outlook message as described herein with reference to FIGS. 2-3. In certain examples, the operations of block 1120 may be performed by the receiver 405 as described herein with reference to FIG. 4.

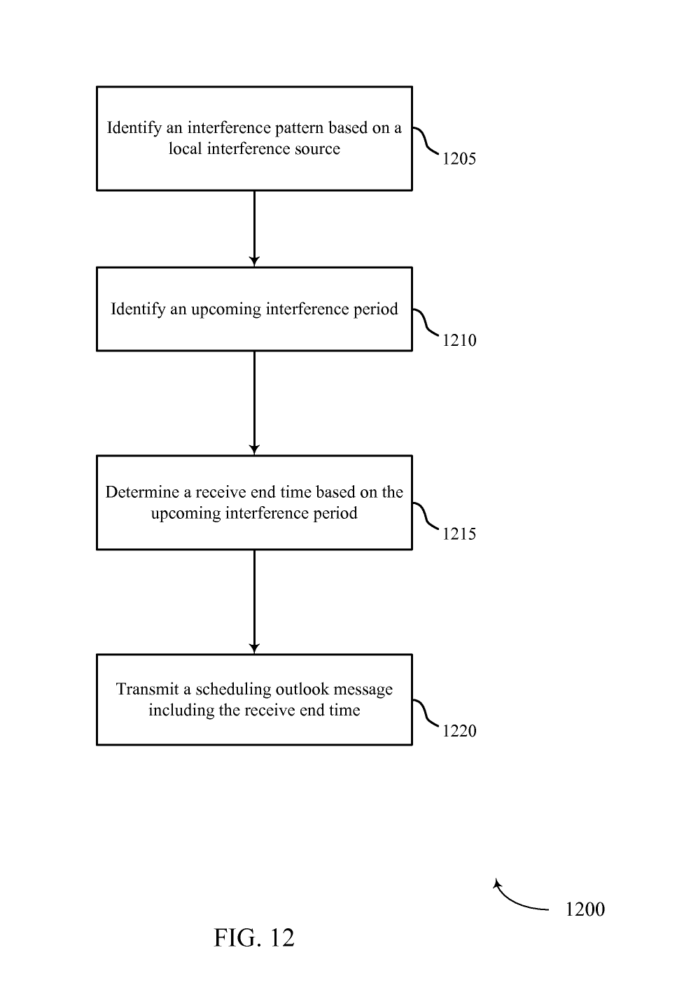

FIG. 12 shows a flowchart illustrating a method 1200 for modified CTS or block acknowledgement for coexistence in accordance with various aspects of the present disclosure. The operations of method 1200 may be implemented by a STA 115 or its components as described with reference to FIGS. 1-7. For example, the operations of method 1200 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware. The method 1200 may also incorporate aspects of methods 800, 900, 1000, and 1100 of FIGS. 8-11.

At block 1205, the STA 115 may identify an interference pattern based at least in part on a local interference source, wherein identifying the upcoming interference period is based at least in part on the interference pattern as described herein with reference to FIGS. 2-3. In certain examples, the operations of block 1205 may be performed by the interference identifier 505 as described herein with reference to FIG. 5.

At block 1210, the STA 115 may identify an upcoming interference period as described herein with reference to FIGS. 2-3. In certain examples, the operations of block 1210 may be performed by the interference identifier 505 as described herein with reference to FIG. 5.

At block 1215, the STA 115 may determine a receive end time based at least in part on the upcoming interference period as described herein with reference to FIGS. 2-3. In certain examples, the operations of block 1215 may be performed by the end time manager 510 as described herein with reference to FIG. 5.

At block 1220, the STA 115 may transmit a scheduling outlook message comprising the receive end time as described herein with reference to FIGS. 2-3. In certain examples, the operations of block 1220 may be performed by the scheduling outlook controller 515 as described herein with reference to FIG. 5.

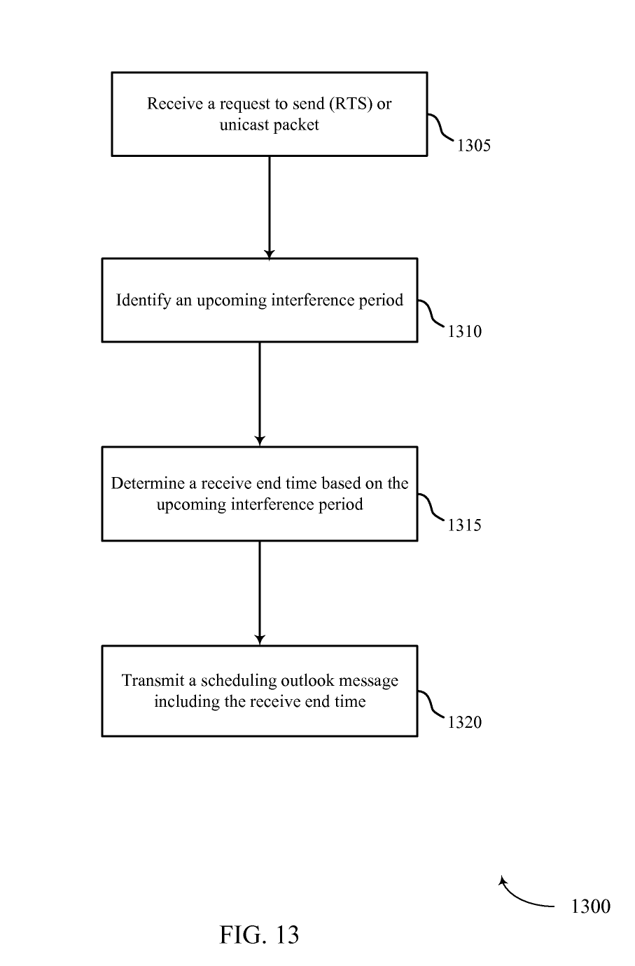

FIG. 13 shows a flowchart illustrating a method 1300 for modified CTS or block acknowledgement for coexistence in accordance with various aspects of the present disclosure. The operations of method 1300 may be implemented by a STA 115 or its components as described with reference to FIGS. 1-7. For example, the operations of method 1300 may be performed by the coexistence manager 410 as described with reference to FIGS. 4-7. In some examples, a STA 115 may execute a set of codes to control the functional elements of the STA 115 to perform the functions described below. Additionally or alternatively, the STA 115 may perform aspects the functions described below using special-purpose hardware.

At block 1305, the STA 115 may receiving a request to send (RTS) or unicast packet as described herein with reference to FIGS. 2-3. In certain examples, the operations of block 1305 may be performed by the receiver 405 as described herein with reference to FIG. 5.

At block 1310, the STA 115 may identify an upcoming interference period as described herein with reference to FIGS. 2-3. In certain examples, the operations of block 1310 may be performed by the interference identifier 505 as described herein with reference to FIG. 5.

At block 1315, the STA 115 may determine a receive end time based at least in part on the upcoming interference period as described herein with reference to FIGS. 2-3. In certain examples, the operations of block 1315 may be performed by the end time manager 510 as described herein with reference to FIG. 5.

At block 1320, the STA 115 may transmit a scheduling outlook message comprising the receive end time in response to receiving the RTS or unicast packet as described herein with reference to FIGS. 2-3. In certain examples, the operations of block 1320 may be performed by the scheduling outlook controller 515 as described herein with reference to FIG. 5.

Thus, methods 800, 900, 1000, 1100, 1200, and 1300 may provide for modified CTS or block acknowledgement for coexistence. It should be noted that methods 800, 900, 1000, 1100, and 1200 describe possible implementation, and that the operations and the steps may be rearranged or otherwise modified such that other implementations are possible. In some examples, aspects from two or more of the methods 800, 900, 1000, 1100, 1200, and 1300 may be combined. In some examples, the steps may be performed by a device other than a STA 115, for example, by a device in a WAN system, or another system other than a WLAN.

The detailed description set forth above in connection with the appended drawings describes exemplary configurations and does not represent all the examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
identifying an upcoming interference period;
determining a receive end time based at least in part on the upcoming interference period; and
transmitting a scheduling outlook message comprising the receive end time.

2. The method of claim 1, further comprising:
incorporating the scheduling outlook message into a packet exchange message, wherein transmitting the scheduling outlook message comprises transmitting the packet exchange message.

3. The method of claim 2, further comprising:
hashing a receiver address associated with the packet exchange message, wherein incorporating the scheduling outlook message is based at least in part on the hashed receiver address.

4. The method of claim 2, further comprising:
receiving a short receiver address comprising fewer bits than a receiver address field of the packet exchange message, wherein incorporating the scheduling outlook message is based at least in part on the short receiver address.

5. The method of claim 1, further comprising:
receiving a request to send (RTS) or unicast packet, wherein transmitting the scheduling outlook message is in response to receiving the unicast packet.

6. The method of claim 2, wherein the scheduling outlook message is incorporated in a receiver address field of the packet exchange message.

7. The method of claim 2, wherein the packet exchange message is an automatic response message.

8. The method of claim 7, wherein the automatic response message is a clear-to-send (CTS) frame.

9. The method of claim 2, wherein the packet exchange message is a block acknowledgement message.

10. The method of claim 1, further comprising:
receiving a data transmission based at least in part on the scheduling outlook message.

11. The method of claim 10, wherein the data transmission comprises at least a duration, or a modulation and coding scheme (MCS), or a start time, or an end time, or a combination thereof based at least in part on the scheduling outlook message.

12. The method of claim 1, wherein the scheduling outlook message comprises at least a number of supported spatial streams, or a supported bandwidth, or a tone allocation unit (TAU) bitmap, or an interference level, or a combination thereof.

13. The method of claim 1, further comprising:
identifying an interference pattern based at least in part on a local interference source, wherein identifying the upcoming interference period is based at least in part on the interference pattern.

14. The method of claim 13, wherein the interference pattern is based at least in part on a periodic interference pattern, or a quasi-periodic interference pattern, or an aperiodic interference pattern, or a combination thereof.

15. The method of claim 13, wherein the local interference source is a collocated device.

16. The method of claim 13, wherein the local interference source is at least a Bluetooth device, or a human interface device, or a wide area network (WAN) device, or a combination thereof.

17. The method of claim 1, wherein the receive end time is based at least in part on the beginning of the upcoming interference period.

18. An apparatus for wireless communication, comprising:
an interference identifier for identifying an upcoming interference period;
an end time manager for determining a receive end time based at least in part on the upcoming interference period; and
a scheduling outlook controller for transmitting a scheduling outlook message comprising the receive end time.

19. The apparatus of claim 18, further comprising:
the scheduling outlook controller for incorporating the scheduling outlook message into a packet exchange message, wherein transmitting the scheduling outlook message comprises transmitting the packet exchange message.

20. The apparatus of claim 19, further comprising:
an RA hasher for hashing a receiver address associated with the packet exchange message, wherein incorporating the scheduling outlook message is based at least in part on the hashed receiver address.

21. The apparatus of claim 19, further comprising:
a short RA controller for receiving a short receiver address comprising fewer bits than a receiver address field of the packet exchange message, wherein incorporating the scheduling outlook message is based at least in part on the short receiver address.

22. The apparatus of claim 19, wherein the scheduling outlook message is incorporated in a receiver address field of the packet exchange message.

23. The apparatus of claim 19, wherein the packet exchange message is an automatic response message.

24. The apparatus of claim 18, further comprising:
a receiver for receiving a data transmission based at least in part on the scheduling outlook message.

25. The apparatus of claim 18, further comprising:
the interference identifier for identifying an interference pattern based at least in part on a local interference source, wherein identifying the upcoming interference period is based at least in part on the interference pattern.

26. An apparatus for wireless communication, comprising:
a processor;
memory in electronic communication with the processor; and
instructions stored in the memory and operable, when executed by the processor, to cause the apparatus to:
identify an upcoming interference period;
determine a receive end time based at least in part on the upcoming interference period; and
transmit a scheduling outlook message comprising the receive end time.

27. The apparatus of claim 26, wherein the instructions are operable to cause the processor to:
incorporate the scheduling outlook message into a packet exchange message, wherein transmitting the scheduling outlook message comprises transmitting the packet exchange message.

28. The apparatus of claim 27, wherein the instructions are operable to cause the processor to:
hash a receiver address associated with the packet exchange message, wherein incorporating the scheduling outlook message is based at least in part on the hashed receiver address.

29. The apparatus of claim 27, wherein the instructions are operable to cause the processor to:
receive a short receiver address comprising fewer bits than a receiver address field of the packet exchange message, wherein incorporating the scheduling outlook message is based at least in part on the short receiver address.

30. The apparatus of claim 26, wherein the instructions are operable to cause the processor to:
identify an interference pattern based at least in part on a local interference source, wherein identifying the upcoming interference period is based at least in part on the interference pattern.

31. A non-transitory computer-readable medium storing code for wireless communication, the code comprising instructions executable to:
identify an upcoming interference period;
determine a receive end time based at least in part on the upcoming interference period; and
transmit a scheduling outlook message comprising the receive end time.
